(19) United States
(12) Patent Application Publication
(10) Pub. No.: US 2026/0258684 A1
(43) Pub. Date: Sep. 3, 2026

(54) INDICATOR FOR FUEL FILLER OR CHARGE PORT DOOR

(71) Applicant: Ford Global Technologies, LLC, Dearborn, MI (US)

(72) Inventor: Isaias Abner Garcia Vergara, Tlalpan (MX)

(21) Appl. No.: 19/066,241

(22) Filed: Feb. 28, 2025

(51) Int. Cl. E05D 7/12; E05D 5/08

(52) U.S. Cl. CPC E05D 7/121; E05D 5/08; E05Y 2201/624; E05Y 2600/58; E05Y 2600/622; E05Y 2900/534

(57) ABSTRACT

A vehicle assembly includes a hinge having a first end portion and a second end portion. The first end portion is pivotably connected to a vehicle. The second end portion provides a mount. A door is slidably interlocked with the mount. The hinge is configured to pivot the door back-and-forth between a closed position and an open position when the door is slidably interlocked with the mount. An indicator is configured to be viewed through an aperture in the mount when the door is slidably interlocked with the mount.

### TECHNICAL FIELD

This disclosure relates generally to installing a fuel filler or charge port door and, more particularly, to confirming that such a door is installed.

### BACKGROUND

Some vehicles include access doors that, when closed, cover a fuel filler or a charge port. The doors can pivot from the closed position to an open position to provide access to the fuel filler or the charge port. Connections that couple the access door to the vehicle can be hidden from view.

In some aspects, the techniques described herein relate to a vehicle assembly, including: a hinge having a first end portion and a second end portion, the first end portion pivotably connected to a vehicle, the second end portion providing a mount; a door slidably interlocked with the mount, the hinge configured to pivot the door back-and-forth between a closed position and an open position when the door is slidably interlocked with the mount; and an indicator configured to be viewed through an aperture in the mount when the door is slidably interlocked with the mount.

In some aspects, the techniques described herein relate to a vehicle assembly, wherein the indicator is a post of the door.

In some aspects, the techniques described herein relate to a vehicle assembly, wherein the post is configured to receive a fastener that secures the mount to the door.

In some aspects, the techniques described herein relate to a vehicle assembly, wherein a portion of the mount retains the post within the aperture when the door is interlocked with the mount.

In some aspects, the techniques described herein relate to a vehicle assembly, wherein the door is snap-fit to the mount.

In some aspects, the techniques described herein relate to a vehicle assembly, further including a flexible tab that flexes as the door is slidably interlocked with the door.

In some aspects, the techniques described herein relate to a vehicle assembly, wherein the aperture is provided within a frustoconical portion of the mount.

In some aspects, the techniques described herein relate to a vehicle assembly, further including a stand-off extending from the frustoconical portion, the stand-off blocking movement of indicator past the aperture as the door is slidably interlocked with the mount.

In some aspects, the techniques described herein relate to a vehicle assembly, further including a flexible tab that flexes as the door is slidably interlocked with the door, the stand-off on a first side of the aperture, the flexible tab on an opposite, second side of the aperture.

In some aspects, the techniques described herein relate to a vehicle assembly, further including a plurality of door hooks and a plurality of mount hooks, the plurality of door hooks interlocked with the plurality of mount hooks to slidably interlock the door to the mount.

In some aspects, the techniques described herein relate to a vehicle assembly, wherein the door in the closed position blocks access to a fuel filler of the vehicle, wherein the door in the open position permits access to the fuel filler of the vehicle.

In some aspects, the techniques described herein relate to a vehicle assembly, wherein the door in the closed position blocks access to a charge port of the vehicle wherein the door in the open position permits access to the charge port of the vehicle.

In some aspects, the techniques described herein relate to a vehicle assembly, wherein the door in closed position blocks access through an aperture in an outer panel of the vehicle, wherein the door in the open position permits access through the aperture in the outer panel of the vehicle.

In some aspects, the techniques described herein relate to a vehicle assembly, including: a hinge having a mount with an aperture; and a door assembly having an indicator, the door assembly configured to transition from an uninstalled position with the mount to an installed position with the mount, the indicator portion aligned the aperture when the door assembly is in the installed position, the indicator portion misaligned with the aperture when the door assembly is in the uninstalled position.

In some aspects, the techniques described herein relate to a vehicle assembly, wherein the indicator is a projection from the door assembly.

In some aspects, the techniques described herein relate to a vehicle assembly, wherein the door assembly slidably interlocks with the mount when transitioning from the uninstalled position to the installed position.

In some aspects, the techniques described herein relate to a vehicle assembly, wherein the door assembly is a charge port door assembly fuel filler door assembly.

In some aspects, the techniques described herein relate to a vehicle component engagement verification method, including: sliding an access door into an engaged position with a mount of a hinge; and verifying that the access door is in the engaged position by confirming that an indicator is aligned with an aperture within the mount, the access door a fuel filler door or a charged port door.

In some aspects, the techniques described herein relate to a vehicle component engagement verification method, further including wherein confirming that the indicator is aligned with the aperture includes a visual confirmation of the alignment.

In some aspects, the techniques described herein relate to a vehicle component engagement verification method, further including, after the sliding, extending a fastener through the aperture to secure the access door to the mount.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of a vehicle having an access door that can cover a charge port with the access door shown in an open position.

FIG. 2 illustrates a section view taken at line 2–2 in FIG. 2 through a charge port of the vehicle.

FIG. 3 illustrates a perspective view of the access door and a hinge when the access door is moving to a position where the access door is slidably interlocked with a mount of the hinge in an installed position.

FIG. 4 illustrates a section view taken at line 5–5 in FIG. 2 when the access door is moving closer to a position where the access door is slidably interlocked with a mount of the hinge in the installed position.

FIG. 5 illustrates a section view taken at the line 5–5 in FIG. 3 when the access door is in the installed position.

FIG. 6 illustrates a close-up perspective view of an indicator portion of the access door.

FIG. 7 illustrates a close-up perspective view of a portion of the mount having an aperture through which the indicator portion of the access door can be viewed.

### DETAILED DESCRIPTION

This disclosure relates generally to a door that can cover a charge port or a fuel filler of a vehicle. During installation, the door can be slidably engaged with a mount of a hinge. A user can rotate the door and the hinge from a closed position to an open position to give the user access to the charge port or the fuel filler. This disclosure is, in particular, directed toward an indicator that can help confirm whether or not the door is slidably engaged with the mount and in an installed position.

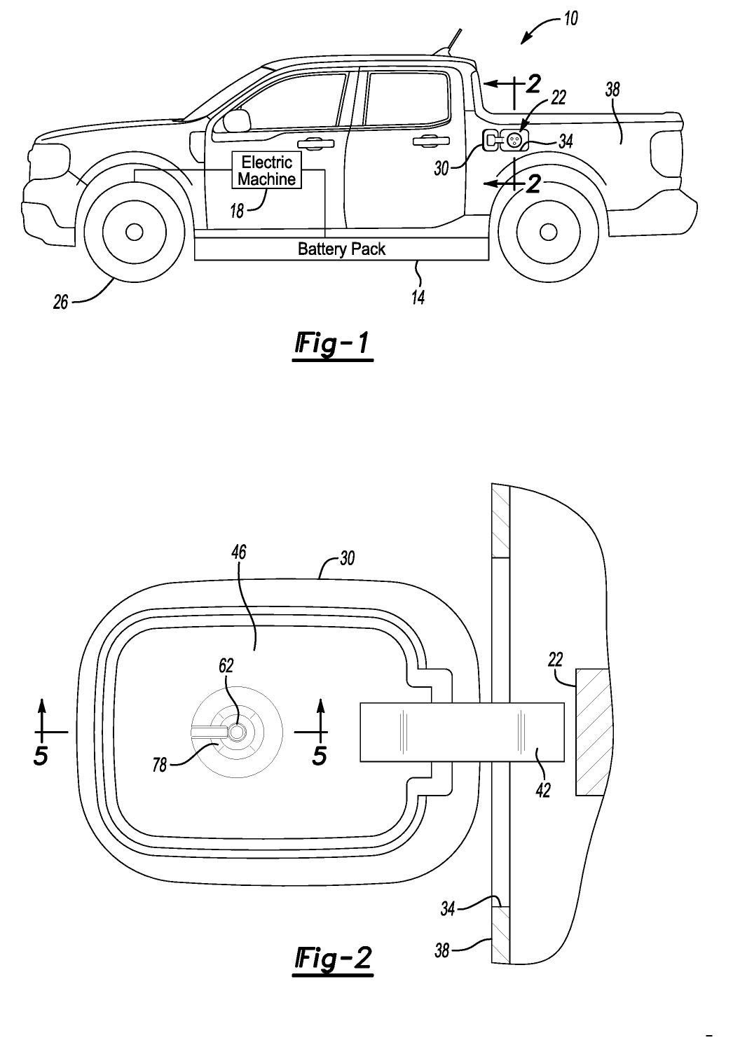

With reference to FIG. 1, an electrified vehicle 10 includes a traction battery 14, an electric machine 18, a charge port 22, and wheels 26. The electric machine 18 is configured to receive electrical power from the battery 14, and to convert that electrical power to torque to drive the wheels 26. Through the charge port 22, the traction battery 14 can be recharged. For example, electric vehicle supply equipment (EVSE) can include a charger that a user can couple to the charge port 22 to charge the traction battery 14 from a power source outside the vehicle 10, such as a grid power source.

The vehicle 10 includes a door 30 or cover that can move from the open position shown in FIG. 1 to a closed position where the door 30 blocks access through an aperture 34 in an outer panel 38 of the vehicle 10 to the charge port 22. The door 30 is maintained in the closed position during ordinary operation of the vehicle 10. The door 30 is moved to the open position shown when access to the charge port 22 through the aperture 34 in the outer panel 38 is desired.

With reference now to FIG. 2 and continued reference to FIG. 1, the door 30 is mounted to a hinge arm 42 to facilitate pivoting the door 30 back-and-forth between the open position and the closed position. More particularly, the door 30 is mounted to a mount 46 or mounting platform at one end of the hinge arm 42. The opposite end of the hinge arm 42 is pivotably connected to the vehicle 10.

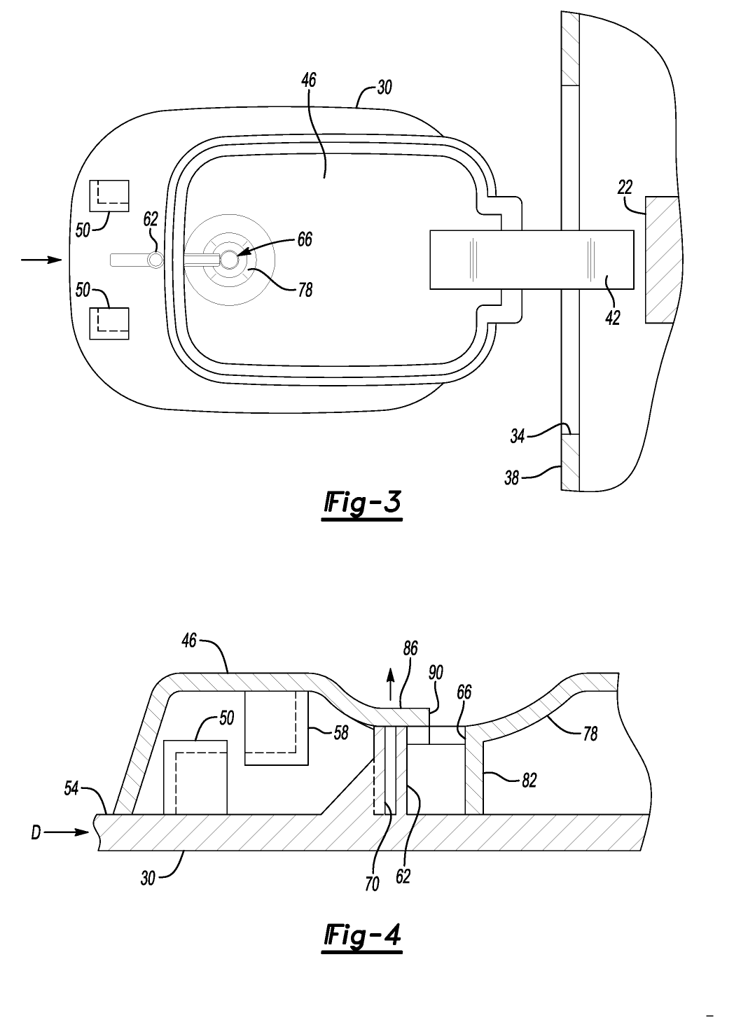

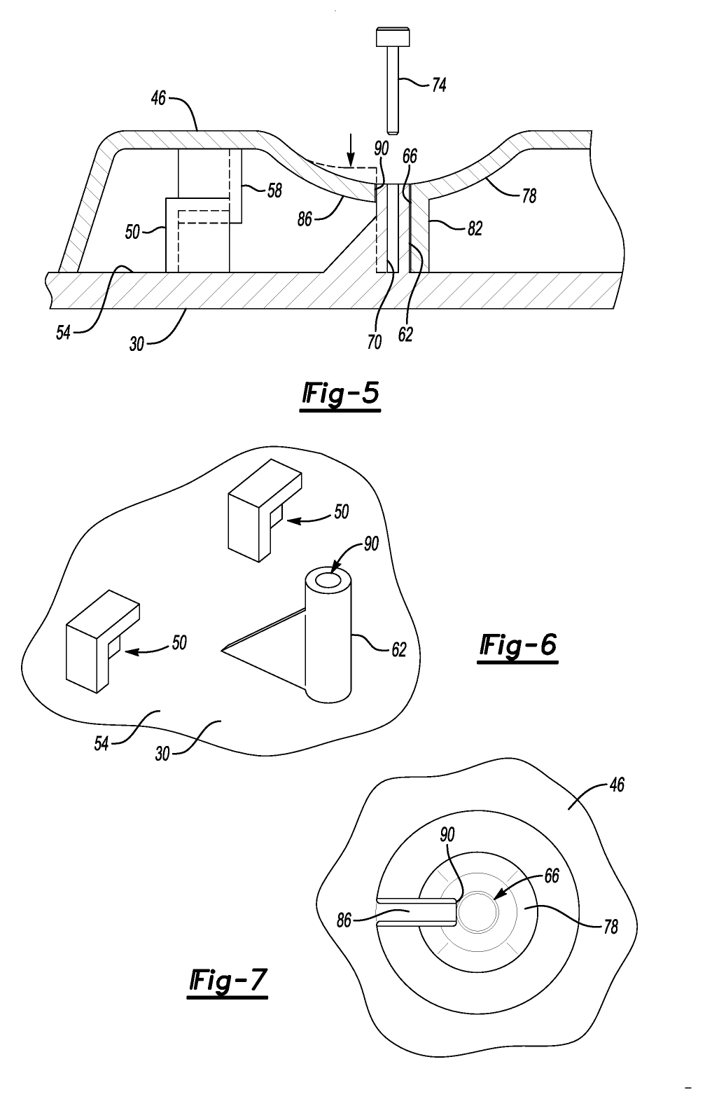

With reference now to FIGS. 3–7 and continuing reference to FIGS. 1 and 2, in the exemplary embodiment, the door 30 slidably interlocks with the mount 46 to secure the door 30 to the mount 46. FIG. 3 shows the door 30 moving toward the installed position of FIG. 2 where the door 30 is slidably interlocked to the mount 46. FIG. 4 shows a section view of selected areas of the door 30 and the mount 46 as the door 30 slides in a direction D relative to the mount 46 in an installed position. FIG. 5 then shows those same portions when the mount 46 and the door 30 are slidably interlocked.

To facilitate the slidable mounting, the door 30 includes a plurality of door hooks 50 extending from a back side 54 of the door 30. As the door 30 is translated in a direction D relative to the mount 46, the door hooks 50 interlock with corresponding mount hooks 58. Slidably interlocking the mount hooks 58 with the door hooks 50 secures the door 30 to the mount 46. As can be appreciated, if the door 30 does not slide relative to the mount 46 in the direction D a sufficient amount, the mount hooks 58 and the door hooks 50 may not interlock with each other.

To ensure that the door 30 slides a sufficient amount such that the door 30 is in an installed position relative to the mount 46, the example hinge arm 42 and door 30 are equipped with an indicator system. In the exemplary embodiment, the indicator system includes an indicator 62 extending from the back side 54 of the door 30. When the door 30 is in an installed position relative to the mount 46, the indicator 62 is aligned with an aperture 66 within the mount 46. An assembler can, for example, look through the aperture 66 to visually see the indicator 62 being aligned with the aperture 66. The assembler then is ensured that the door 30 is in the installed position relative to the mount 46.

The indicator 62 is, in the exemplary embodiment, a post. The post includes a bore 70. After confirming that the indicator 62 is properly aligned with the aperture 66, the operator could, in some examples, extend a fastener 74 such as a threaded fastener, through the aperture 66 to be received within the bore 70 and threadably engage the indicator 62. The fastener 74 can help to hold the door 30 relative to the mount 46.

The mount 46, in the exemplary embodiment, includes a frustoconical portion 78. The aperture 66 is in the frustoconical portion. A stand off 82 extends from the mount 46 on a first side of the aperture 66. The stand off 82 can block movement of the indicator 62, and thus movement of the door 30 to a position where the indicator 62 slides in the direction D past the aperture 66. As the door 30 is moved relative to the mount 46 in the direction D, the indicator 62 can contact a flexible tab 86 disposed on a side of the aperture 66 opposite the stand off 82. As the indicator 62 contacts the flexible tab 86, the flexible tab 86 flexes to permit continued movement of the door 30 in the direction D.

After the indicator 62 has moved into a position where the indicator 62 is aligned with the aperture 66, the indicator 62 no longer flexes the flexible tab 86. The flexible tab 86 then returns to the unflexed position to capture the indicator 62 between an end portion 90 of the flexible tab 86 and the stand off 82. The flexible tab 86 and the stand off 82 can facilitate positioning of the indicator 62, and thus the door 30, in a position where the indicator 62 is aligned with the aperture 66 to ensure that the door 30 is in a properly installed position relative to the mount. Due to the flexible tab 86 flexing and then snapping back to a home position when no longer contacted by the indicator 62, the door 30 can be considered to snap fit to the mount 46.

The indicator 62, while shown as a post, could be another type of indicator in another example, such as another projection from the back side 54 of the door 30.

Although the exemplary door 30 and hinge arm 42 are utilized to cover the charge port 22, a similar system could be incorporated into a conventional vehicle that relies on an internal combustion engine for propulsion. Such the vehicle can be filled refueled through a fuel filler. That is, the teachings of this disclosure, although described in connection with the door 30 of the electrified vehicle 10, are applicable to access doors utilized to cover other openings in outer panels of vehicles, such as openings permitting access to fuel fillers. Such doors would be considered fuel filler doors.

An exemplary verification method utilizing the indicator 62 and aperture 66 can involve an operator sliding the door 30 toward an engaged position with a mount 46 of a hinge arm 42. The operator can then verify that the door 30 or access door is in the engaged position by confirming that the indicator 62 is aligned with the aperture 66 of the mount 46. The confirmation maybe a visual confirmation by the operator. Alternatively, the operator could attempt to drive a fastener into the indicator 62. When the indicator 62 is aligned, the fastener is able to engage the indicator 62. If the indicator 62 is misaligned, the fastener is unable to engage the indicator 62 and the operator can recognize that the door 30 is not yet in the engaged position.

Features of the disclosed examples include a method and system for confirming installation and positioning of access doors within vehicle. The access doors can be utilized to block access to a charge port in some examples. In other examples the access doors can be used to block access to a fuel filler of a vehicle.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle assembly, comprising:
a hinge having a first end portion and a second end portion, the first end portion pivotably connected to a vehicle, the second end portion providing a mount;
a door slidably interlocked with the mount, the hinge configured to pivot the door back-and-forth between a closed position and an open position when the door is slidably interlocked with the mount; and
an indicator configured to be viewed through an aperture in the mount when the door is slidably interlocked with the mount.

2. The vehicle assembly of claim 1, wherein the indicator is a post of the door.

3. The vehicle assembly of claim 2, wherein the post is configured to receive a fastener that secures the mount to the door.

4. The vehicle assembly of claim 2, wherein a portion of the mount retains the post within the aperture when the door is interlocked with the mount.

5. The vehicle assembly of claim 1, wherein the door is snap-fit to the mount.

6. The vehicle assembly of claim 1, further comprising a flexible tab that flexes as the door is slidably interlocked with the door.

7. The vehicle assembly of claim 1, wherein the aperture is provided within a frustoconical portion of the mount.

8. The vehicle assembly of claim 7, further comprising a stand-off extending from the frustoconical portion, the stand-off blocking movement of indicator past the aperture as the door is slidably interlocked with the mount.

9. The vehicle assembly of claim 8, further comprising a flexible tab that flexes as the door is slidably interlocked with the door, the stand-off on a first side of the aperture, the flexible tab on an opposite, second side of the aperture.

10. The vehicle assembly of claim 1, further comprising a plurality of door hooks and a plurality of mount hooks, the plurality of door hooks interlocked with the plurality of mount hooks to slidably interlock the door to the mount.

11. The vehicle assembly of claim 1, wherein the door in the closed position blocks access to a fuel filler of the vehicle, wherein the door in the open position permits access to the fuel filler of the vehicle.

12. The vehicle assembly of claim 1, wherein the door in the closed position blocks access to a charge port of the vehicle wherein the door in the open position permits access to the charge port of the vehicle.

13. The vehicle assembly of claim 1, wherein the door in closed position blocks access through an aperture in an outer panel of the vehicle, wherein the door in the open position permits access through the aperture in the outer panel of the vehicle.

14. A vehicle assembly, comprising:
a hinge having a mount with an aperture; and
a door assembly having an indicator, the door assembly configured to transition from an uninstalled position with the mount to an installed position with the mount, the indicator portion aligned the aperture when the door assembly is in the installed position, the indicator portion misaligned with the aperture when the door assembly is in the uninstalled position.

15. The vehicle assembly of claim 14, wherein the indicator is a projection from the door assembly.

16. The vehicle assembly of claim 14, wherein the door assembly slidably interlocks with the mount when transitioning from the uninstalled position to the installed position.

17. The vehicle assembly of claim 14, wherein the door assembly is a charge port door assembly fuel filler door assembly.

18. A vehicle component engagement verification method, comprising:
sliding an access door into an engaged position with a mount of a hinge; and
verifying that the access door is in the engaged position by confirming that an indicator is aligned with an aperture within the mount, the access door a fuel filler door or a charged port door.

19. The vehicle component engagement verification method of claim 18, further comprising wherein confirming that the indicator is aligned with the aperture comprises a visual confirmation of the alignment.

20. The vehicle component engagement verification method of claim 18, further comprising, after the sliding, extending a fastener through the aperture to secure the access door to the mount.
